(19) United States
(12) Patent Application Publication
(10) Pub. No.: US 2010/0133096 A1
(43) Pub. Date: Jun. 3, 2010

(54) Use of Austenitic Stainless Steel as Construction Material in a Device or Structural Component Which is Exposed to an Oxygen and/or Hydrogen and/or Hydrofluoric Acid Environment

(75) Inventors: Rolf Steen Hansen, Stathelle (NO); Sten Egil Johnsen, Porsgrunn (NO); Hans Jörg Fell, Stathelle (NO); Egil Rasten, Porsgrunn (NO)

Correspondence Address: WENDEROTH, LIND & PONACK, L.L.P., 1030 15th Street, N.W.,, Suite 400 East, Washington, DC, 20005-1503, US

(73) Assignee: HYDROGEN TECHNOLOGIES AS, Notodden (NO)

(21) Appl. No.: 12/308,895

(22) PCT Filed: Jun. 27, 2007
(86) PCT No.: PCT/NO2007/000235

§ 371 Date: Jun. 17, 2009

(30) Foreign Application Priority Data
Jun. 28, 2006 (NO) 20063008

(51) Int. Cl. C22C 38/42; C22C 30/02; C22C 19/05; H01M 2/02; C25B 9/18

(52) U.S. Cl. 204/242; 420/49; 420/582; 420/454

(57) ABSTRACT

Use of an austenitic stainless steel wherein the chemical composition comprises 10-20 weight % nickel, 10-20 weight % chromium, 30-50 weight % iron, maximum 17 weight % of another element or elements and the balance iron and/or chromium and/or nickel as construction material in a device or structural components that are exposed to an oxygen and/or a hydrogen and/or a hydrofluoric acid environment.

The present invention concerns the use of austenitic stainless steel as material in a device or structural component which is exposed to an oxygen- and/or hydrogen- and/or hydrofluoric acid environment.

The present invention is particularly suitable for a PEM (Polymer Electrolyte Membrane) electrolyser, but also all other devices containing a PEM such as fuel cells. Typical operating conditions for water electrolysis with a PEM electrolyser are, but not limited to, temperatures from 10° C. to 100° C. and a pressure range from ambient to 50 bar.

The material in said devices and structural components might be degraded when exposed to an oxygen and/or hydrogen and/or hydrofluoric acid environment.

If said device is an electrolyser for electrolysis of water and comprises a polymer electrolyte membrane, trace amounts of hydrofluoric (HF) acid will be found in the water. Thereby the process water turns corrosive. Thus standard construction materials such as grade 316 stainless steel will corrode. The corrosion will release corrosion products as e.g. Fe²⁺, Ni²⁺ and Cr²⁺. These corrosion products will be accumulated in the membrane and thereby reduce its lifetime. In order to assure an acceptable performance of the membrane throughout the service life, the construction material of the electrolyser ideally should be inert. Therefore the requirements to corrosion resistance are extremely high in these applications and exceed the normal requirements for maintaining the integrity of the construction throughout the service life.

If said device is an electrolyser, parts of the vessel will be exposed to pure oxygen gas. The respective construction material must be compatible to oxygen under operating conditions. This requires both high ignition temperature and low combustion heat.

Furthermore, if said device is an electrolyser, parts of the vessel will be exposed to hydrogen. Therefore the respective construction material must not be susceptible to hydrogen embrittlement.

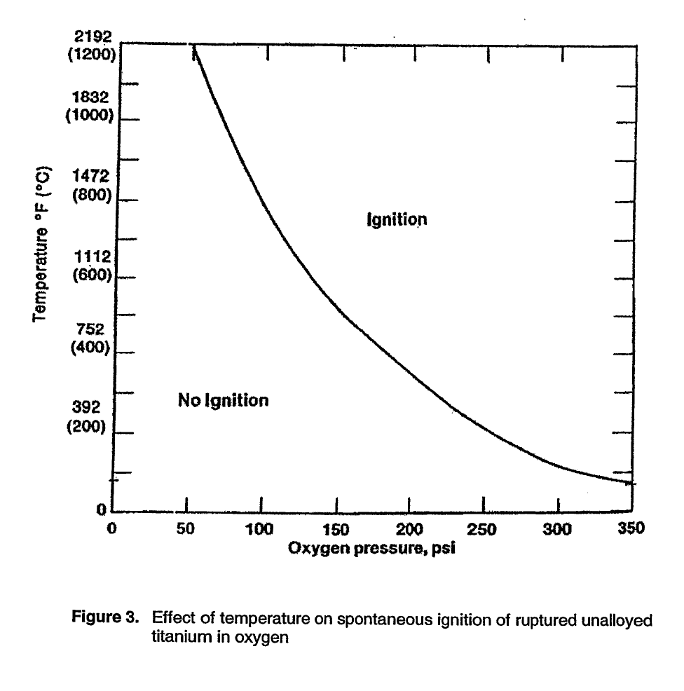

Hitherto titanium or platinum plated steel have been the preferred construction material for a PEM electrolyser. For commercial units, the use of platinum plated steel as a construction material is excluded due to high production costs. Furthermore, titanium needs to be excluded due to corrosion and oxygen incompatibility. This applies in particular for devices operating at higher pressure as illustrated in FIG. 3. This figure shows a dramatic reduction of the ignition temperature of ruptured unalloyed titanium surfaces with increasing pressure (Fred E. Littman and Frank M. Church, “Reactions of Metals with Oxygen and Steam”, Stanford Research Institute to Union Carbide Nuclear Co., Final Report AECU-4092, Feb. 15, 1959). For instance, above approximately 20 bars (corresponding to 290 psi) the ignition temperature is below 100 deg C.

From the perspective of corrosion and O₂ compatibility, Ni-based alloys would be the material of choice as they are among the most corrosion resistant materials in hydrofluoric acid. However, there is a potential risk of hydrogen embrittlement for pure Ni and some nickel alloys such as Monel (i.e. an alloy of nickel and copper and other metals), (NASA, NSS 1740.16, “Guidelines for Hydrogen System Design, Materials Selection, Operations, Storage and Transportation” and Sourcebook Hydrogen Applications, Appendix 4: Hydrogen Embrittlement and Material Selection.)

From WO 2004/111285 A1 it is known an austenitic stainless steel, which is corrosion resistant in high-pressure pure hydrogen gas. Due to a specific surface modification this material is particular resistant to hydrogen embrittlement and therefore suitable for apparatus and structural components that are exposed to high pressure hydrogen environment. However, said steel has so far not been considered, evaluated or tested for multiphase chemical environments containing trace amounts of fluorides, as found for instance in a PEM electrolyser.

Stainless steel grade 316 fulfill the requirements to oxygen and hydrogen compatibility, but are generally not recommended in hydrofluoric acid environments due to their corrosion properties (Materials Selector for Hazardous Chemicals, MS 4: Hydrogen Fluoride and Hydrofluoric Acid, MTI 2003, ISBN 1 57698 023 5). As shown in the present example these materials corrode also in environments containing trace amounts of HF.

The main objective of the present invention was to provide a construction material for a device or structural components which is compatible with respect to O₂, shows acceptable resistance towards H₂ embrittlement and show sufficient corrosion resistance in hydrofluoric acid.

Another objective of the present invention was to provide a construction material for a PEM electrolyser and its structural components which is compatible with respect to O₂, shows acceptable resistance towards H₂ embrittlement and show sufficient corrosion resistance in hydrofluoric acid.

The inventors found that these objectives were achieved by using an austenitic stainless steel wherein the chemical composition comprises 10-20 weight % nickel, 10-20 weight % chromium, 30-50 weight % iron, maximum 17 weight % of another element or elements and the balance iron and/or chromium and/or nickel as construction material.

Said element is an alloying element preferably chosen from the group: N, Mn, Mo, Cu, Nb, Ti, V, Ce, B, W, Si.

The inventors found that a preferred material to use was an austenitic stainless steel wherein the chemical composition comprises 10 weight % nickel, 10.5 weight % chromium, 30 weight % iron, maximum 17 weight % of another element or elements and the balance iron and/or chromium and/or nickel as construction material.

The inventors found that a more preferred material to use was an austenitic stainless steel wherein the chemical composition comprises 10 weight % nickel, 10.5 weight % chromium, 30 weight % iron, 0.5-2 weight % copper, maximum 16.5 weight % of another element or elements and the balance iron and/or chromium and/or nickel as construction material.

The inventors found that an even more preferred material to use was an austenitic stainless steel wherein the chemical composition comprises 10 weight % nickel, 10.5 weight % chromium, 30 weight % iron, 3-8 weight % molybdenum, 0.5-2 weight % copper, maximum 13.5 weight % of another element or elements and the balance iron and/or chromium and/or nickel as construction material.

The inventors found that an even more preferred material to use was an austenitic stainless steel wherein the chemical composition comprises 20 weight % nickel, 20 weight % chromium, 30-50 weight % iron, maximum 12.5 weight % of another element or elements and the balance chromium and/or nickel as construction material.

The inventors found that an even more preferred material to use was an austenitic stainless steel wherein the chemical composition comprises 20 weight % nickel, 20 weight % chromium, 30-50 weight % iron, 0.5-2 weight % copper, maximum 12 weight % of another element or elements and the balance chromium and/or nickel as construction material.

The inventors found that an even more preferred material to use was an austenitic stainless steel wherein the chemical composition comprises 20 weight % nickel, 20 weight % chromium, 30-50 weight % iron, 3-8 weight % molybdenum, 0.5-2 weight % copper, maximum 9 weight % of another element or elements and the balance chromium and/or nickel as construction material.

Said austenitic stainless steels are materials particularly suitable for the PEM electrolyser operating conditions. They are compatible with respect to O₂, show acceptable resistance towards H₂ embrittlement and show sufficient corrosion resistance in hydrogen fluoride.

The present invention will be further explained and elucidated in connection with the following example and the attached figures where

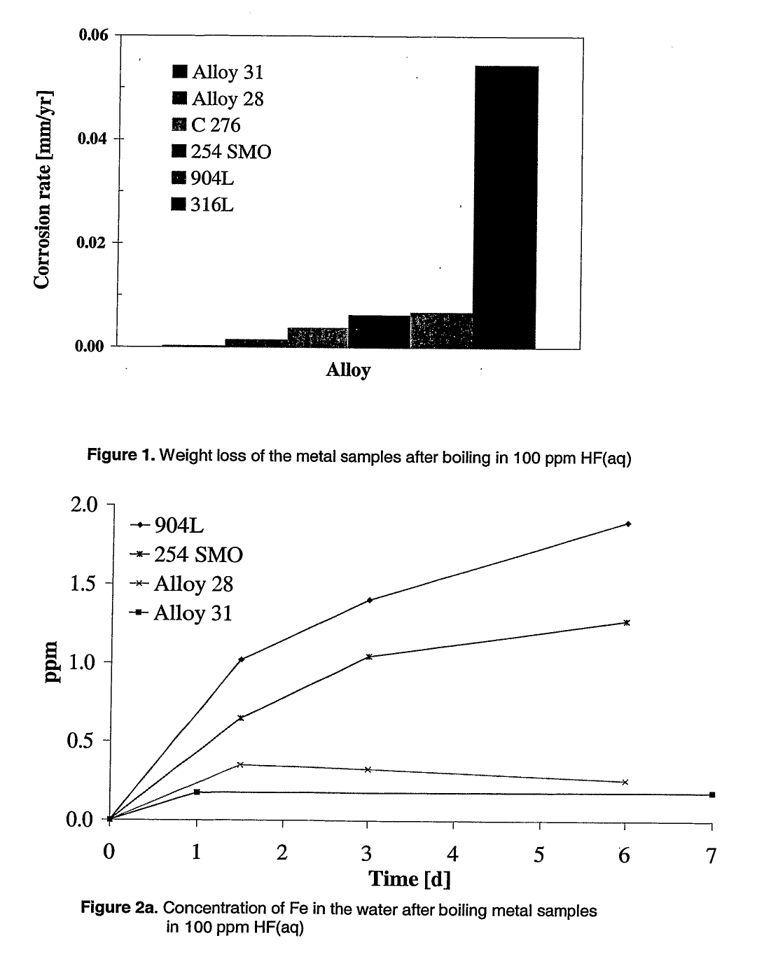

FIG. 1 shows weight loss of metal samples after boiling in 100 ppm HF(aq),

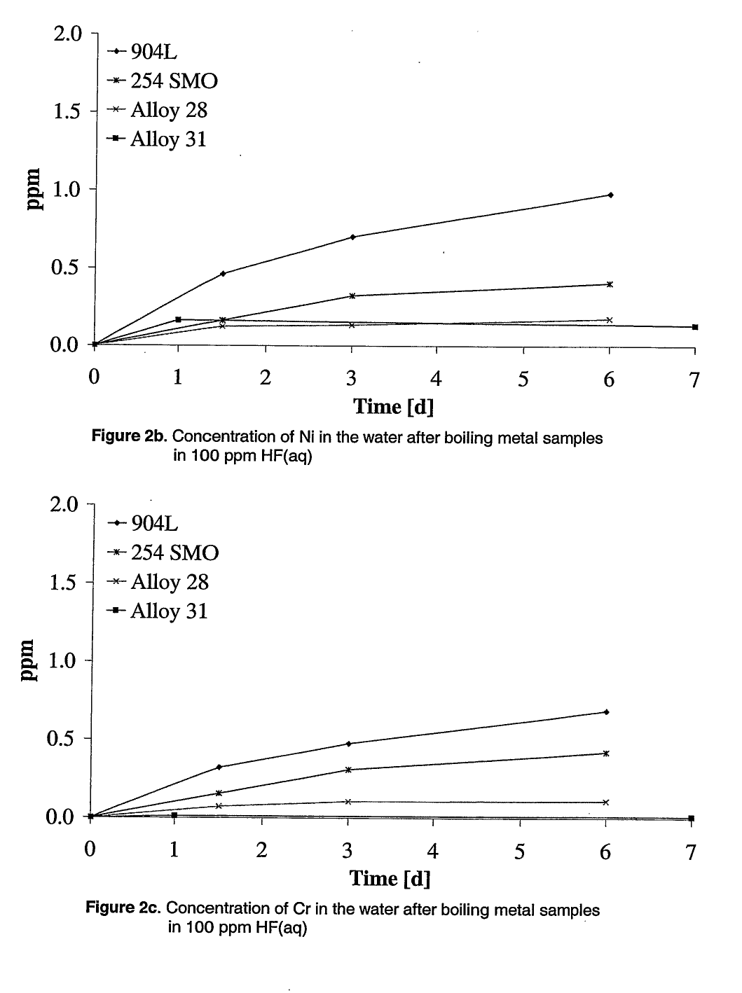

FIG. 2a shows concentration of Fe in water after boiling metal samples in 100 ppm HF(aq),

FIG. 2b shows concentration of Ni in water after boiling metal samples in 100 ppm HF(aq),

FIG. 2c shows concentration of Cr in water after boiling metal samples in 100 ppm HF(aq),

FIG. 3 shows effect of temperature on spontaneous ignition of ruptured unalloyed titanium in oxygen.

### EXAMPLE

### Material Loss Due to Corrosion in De-Ionized Water Added 100 ppm of HF

Tests have been performed with de-ionized water added 100 ppm of hydrogen fluoride and the resulting pH before start of exposure was 2.8. Metal samples of the materials, each with surface area of approximately 25 cm², were tested at 100° C. in Teflon apparatus with reflux of evaporated water. Table 1 gives an overview over the materials tested and their respective constituents as determined by XRF, X-Ray Fluorescence Spectroscopy.

TABLE 1
Materials tested.

Alloy

| | Euronorm | Constituents (weight %) | | | | |
|---|---|---|---|---|---|---|
| | no: | Fe | Ni | Cr | Mo | Other elements |
| 316L | 1.4404 | 66.6 | 10.3 | 17.3 | 2.2 | 1.79 Mn, 0.48 Si, |
| | | | | | | 0.41 Cu |
| Alloy 31 | 1.4562 | 32.3 | 31.0 | 26.9 | 6.4 | 1.50 Mn, 1.1 Cu, |
| | | | | | | 0.34 Co |
| Alloy 28 | 1.4563 | 34.7 | 30.9 | 27.3 | 3.4 | 1.75 Mn, 1.0 Cu, |
| | | | | | | 0.59 Si |
| 904L | 1.4539 | 46.3 | 25.4 | 19.8 | 4.4 | 1.8 Mn, 1.4 Cu, |
| | | | | | | 0.47 Si |
| 254 SMO | 1.4547 | 52.8 | 17.9 | 20.0 | 6.8 | 0.69 Cu, 0.55 Mn, |
| | | | | | | 0.35 Si |
| C-276 | 1.4821 | 5.1 | 58.0 | 14.6 | 15.5 | 3.8 W, 1.4 Co, |
| | | | | | | 0.37 Mn |

Water samples were taken and analyzed after 1, 1.5, 3, 6 and 7 days. Weight loss measurements were performed on the coupons at the end of the tests.

A typical fluoride concentration in water in a prototype electrolyser was measured as 40 ppm with pH=3. This means that the actual test conditions with a higher fluoride concentration represent an accelerated test and should mainly be used for ranking of materials.

The tests show that all materials corroded to a varying degree under the test conditions.

The sample of 316L corroded substantially more than the other materials tested. After one day testing of 316L under these conditions, insoluble corrosion products were formed whereby consuming a significant amount of HF. This means that the test conditions for this material changed during exposure and most likely became less severe. The weight loss for alloy 316L is thus regarded to be substantially higher than the result shown in FIG. 1 and estimated to be more than 0.8 mm/yr. Therefore this material (stainless steel of type 316L) should be excluded as a construction material.

Alloy 31 shows best corrosion resistance (lowest weight loss) of the studied materials.

All tested high-alloyed or super austenitic stainless steels, i.e. alloy 31, alloy 28, 904L, 254 SMO, show limited corrosion and are suitable as a construction material.

With respect to membrane contamination, Alloy 31 and Alloy 28 are most suitable as a construction material (lowest release of cations).

All of the suitable materials (Alloy 31, Alloy 28, 254 SMO and 904L) show profiles that level out as a function of time.

This indicates that the levels of contaminants are low and can probably be controlled by continuous bleeding and replacement of process water and/or water purification.

1-8. (canceled)

9. A method of inhibiting degradation of a construction material in a device or structural component that is exposed to an environment comprising hydrofluoric acid and oxygen and/or hydrogen, which comprises fabricating the construction material of an austenitic stainless steel having a chemical composition which comprises
10-31.0 weight % nickel,
10-27.3 weight % chromium,
30-52.8 weight % iron, and
maximum 17 weight % of another element or elements, selected among N, Mn, Mo, Cu, Nb, Ti, V, Ce, B, W, Si and Co.

10. The method according to claim 9,
wherein said composition comprises 0.5-2 weight % copper.

11. The method according to claim 9,
wherein said composition comprises 3-8 weight % molybdenum.

12. The method according to claim 9,
wherein said composition comprises maximum 12.5 weight % of another element or elements.

13. The method according to claim 9,
wherein said composition comprises maximum 12 weight % of another element or elements.

14. The method according to claim 9,
wherein said composition comprises maximum 9 weight % of another element or elements.

15. An electrolyser comprising a housing and a cell stack having at least one electrochemical cell for electrolysis of water at a temperature between 5-100° C. and at a pressure between ambient and 50 bar,
characterised in that
said housing and other structural components of said electrolyser are made of a material which is an austenitic stainless steel in accordance with claim 9.

16. The method according to claim 10,
wherein said composition comprises 3-8 weight % molybdenum.

17. The method according to claim 10,
wherein said composition comprises maximum 9 weight % of another element or elements.

18. The method according to claim 11,
wherein said composition comprises maximum 9 weight % of another element or elements.

19. An electrolyser comprising a housing and a cell stack having at least one electrochemical cell for electrolysis of water at a temperature between 5-100° C. and at a pressure between ambient and 50 bar,
characterised in that
said housing and other structural components of said electrolyser are made of a material which is an austenitic stainless steel in accordance with claim 10.

20. An electrolyser comprising a housing and a cell stack having at least one electrochemical cell for electrolysis of water at a temperature between 5-100° C. and at a pressure between ambient and 50 bar,
characterised in that
said housing and other structural components of said electrolyser are made of a material which is an austenitic stainless steel in accordance with claim 11.

21. An electrolyser comprising a housing and a cell stack having at least one electrochemical cell for electrolysis of water at a temperature between 5-100° C. and at a pressure between ambient and 50 bar,
characterised in that
said housing and other structural components of said electrolyser are made of a material which is an austenitic stainless steel in accordance with claim 12.

22. An electrolyser comprising a housing and a cell stack having at least one electrochemical cell for electrolysis of water at a temperature between 5-100° C. and at a pressure between ambient and 50 bar,
characterised in that
said housing and other structural components of said electrolyser are made of a material which is an austenitic stainless steel in accordance with claim 13.

23. An electrolyser comprising a housing and a cell stack having at least one electrochemical cell for electrolysis of water at a temperature between 5-100° C. and at a pressure between ambient and 50 bar,
characterised in that
said housing and other structural components of said electrolyser are made of a material which is an austenitic stainless steel in accordance with claim 14.
